(19) United States
(12) Patent Application Publication
(10) Pub. No.: US 2024/0106862 A1
(43) Pub. Date: Mar. 28, 2024

(54) VIRTUAL CLOUD WORKLOAD PROTECTION PLATFORM AND RELATED APPLICATION PROGRAMMING INTERFACES

(71) Applicant: INTRUSION, INC., Plano, TX (US)

(72) Inventors: Tommy Joe HEAD, Hebron, TX (US); Blake DUMAS, Allen, TX (US); Jeremy HAMLYN, Adelaide South Australia (AU); Jay PICKETT, The Colony, TX (US); Max Tanner THOMAS, Carrollton, TX (US); Stephen BLYSTONE, Carrollton, TX (US); S Tanner Kline, McKinney, TX (US); A. Benjamin GARTON, Newtown New South Wales (AU); Adam JENKINS, Adelaide South Australia (AU)

(21) Appl. No.: 18/373,198

(22) Filed: Sep. 26, 2023

Related U.S. Application Data
(60) Provisional application No. 63/410,218, filed on Sep. 26, 2022.

(51) Int. Cl. H04L 9/40

(52) U.S. Cl. CPC H04L 63/20; H04L 63/0236; H04L 63/102

(57) ABSTRACT

Systems, methods, apparatuses, and computer program products for providing a virtual cloud workload protection platform. One method may include determining, by a device, whether a data stream is approved or unapproved; and transmitting, by the device, a fetch request to a renderer requesting a network resource requested by a protected client. Another method may include receiving, by a rendering device, a fetch request from a device requesting at least one network resource requested by a protected client; requesting, by the rendering device, the requested at least one requested resource; and rendering, by the rendering device, the at least one requested resource.

### CROSS-REFERENCE TO RELATED APPLICATIONS:

This application claims the benefit of U.S. Provisional Application Ser. No. 63/410,218, filed Sep. 26, 2022, which is herein incorporated by reference in its entirety.

### TECHNICAL FIELD

Each month, millions of Internet domain names are registered that are included in network traffic and email links. A typical organization may resolve over one million distinct domain names each month, and one third of these resolved domains may change each month. In a dynamic landscape, comprehensive cyber threat intelligence, based upon zero-trust principles, may be used to mitigate emerging threats.

### BACKGROUND

Protecting corporate cloud-based services and infrastructure, while simultaneously providing approved access, remains a challenge. These corporate resources require an on-demand system to satisfy their dynamic needs and constant accessibility. Obtaining visibility and protection of the traffic coming from these remote resources may be difficult because they may leverage network infrastructure of the cloud provider, which can be a nebulous, poorly defined network space having security challenges.

Current hybrid work environments may extend network security perimeters outside of the corporate enclave and datacenter to remote workers, mobile devices, and cloud devices. This expanded perimeter can introduce vulnerabilities in an organization, and organizations can no longer trust traffic based solely on where it originates or what network a user may access.

In general, client devices may initiate connections with servers, which may quickly respond to requests, rather than initiating conversations with clients. Clients may communicate with other clients when they become infected, and the infection may then spread laterally inside a network (i.e., “East-West”). Clients may share files with other clients, but this may introduce additional security risks. “North-South” protection may refer to protection against inbound and outbound network traffic, while “East-West” protection may refer to preventing against the lateral spread of infections within an enterprise, both internally and remotely. Some previous techniques relate to a control device performing a filtering function based on a lookup based upon trust, risk, role, and other factors. Such a control device may be a transparent bridge, but may be implemented as any type of device. The control device may implement filtering functions on a client (i.e., agent).

### SUMMARY

In accordance with some example embodiments, a method may include determining, by a device, whether a data stream is approved or unapproved. The method may further include transmitting, by the device, a fetch request to a renderer requesting a network resource requested by a protected client.

In accordance with certain example embodiments, an apparatus may include means for determining whether a data stream is approved or unapproved. The apparatus may further include means for transmitting a fetch request to a renderer requesting a network resource requested by a protected client.

In accordance with various example embodiments, a non-transitory computer readable medium may include program instructions that, when executed by an apparatus, cause the apparatus to perform at least a method. The method may include determining whether a data stream is approved or unapproved. The method may further include transmitting a fetch request to a renderer requesting a network resource requested by a protected client.

In accordance with some example embodiments, a computer program product may perform a method. The method may include determining whether a data stream is approved or unapproved. The method may further include transmitting a fetch request to a renderer requesting a network resource requested by a protected client.

In accordance with certain example embodiments, an apparatus may include at least one processor and at least one memory storing instructions that, when executed by the at least one processor, cause the apparatus at least to determine whether a data stream is approved or unapproved. The at least one memory and instructions, when executed by the at least one processor, may further cause the apparatus at least to transmit a fetch request to a renderer requesting a network resource requested by a protected client.

In accordance with various example embodiments, an apparatus may include determining circuitry configured to perform determining whether a data stream is approved or unapproved. The apparatus may further include transmitting circuitry configured to perform transmitting a fetch request to a renderer requesting a network resource requested by a protected client.

In accordance with some example embodiments, a method may include receiving, by a rendering device, a fetch request from a device requesting at least one network resource requested by a protected client. The method may further include requesting, by the rendering device, the at least one requested resource. The method may further include rendering, by the rendering device, the at least one requested resource.

In accordance with certain example embodiments, an apparatus may include means for receiving a fetch request from a device requesting at least one network resource requested by a protected client. The apparatus may further include means for requesting the at least one requested resource. The apparatus may further include means for rendering the at least one requested resource.

In accordance with various example embodiments, a non-transitory computer readable medium may include program instructions that, when executed by an apparatus, cause the apparatus to perform at least a method. The method may include receiving a fetch request from a device requesting at least one network resource requested by a protected client. The method may further include requesting the at least one requested resource. The method may further include rendering the at least one requested resource.

In accordance with some example embodiments, a computer program product may perform a method. The method may include receiving a fetch request from a device requesting at least one network resource requested by a protected client. The method may further include requesting the at least one requested resource. The method may further include rendering the at least one requested resource.

In accordance with certain example embodiments, an apparatus may include at least one processor and at least one memory storing instructions that, when executed by the at least one processor, cause the apparatus at least to receive a fetch request from a device requesting at least one network resource requested by a protected client. The at least one memory and instructions, when executed by the at least one processor, may further cause the apparatus at least to request the at least one requested resource. The at least one memory and instructions, when executed by the at least one processor, may further cause the apparatus at least to render the at least one requested resource.

In accordance with various example embodiments, an apparatus may include receiving circuitry configured to perform receiving a fetch request from a device requesting at least one network resource requested by a protected client. The apparatus may further include requesting circuitry configured to perform requesting the at least one requested resource. The apparatus may further include rendering circuitry configured to perform rendering the at least one requested resource.

### BRIEF DESCRIPTION OF THE DRAWINGS

FIG. 1 illustrates an example of an application programming interface according to certain embodiments;

FIG. 2 illustrates an example of a cloud architecture according to some embodiments; and

FIG. 3 illustrates an example of an endpoint architecture according to various embodiments.

### DETAILED DESCRIPTION

The disclosures of each of U.S. Pat. Nos. 8,291,058, 8,472,449, U.S. patent application Ser. Nos. 17/405,437, 17/405,408, 17/845,836, and 18/232,240 are herein incorporated by reference in their entirety.

Certain example embodiments described herein may provide systems and methods for continuously securing physical devices, virtual machines, containers, and serverless workloads that may move across different cloud environments by, for example, providing access controls, actively denying unauthorized access, hiding resources from unauthorized devices, monitoring and auditing, safely rendering or stopping communications with untrusted external devices by leveraging large reputation-based and/or role-based datasets accessible locally or remotely, and/or controlling lateral attacks within an enclave or network.

Certain exemplary embodiments discussed herein may enable cybersecurity solution providers to integrate a reputation-based global threat engine into custom real-time applications, appliances, and services to protect on-premises, remote, and cloud users, as well as their respective applications.

Some exemplary embodiments may be associated with a zero-trust principle, wherein by default, domain names or IP addresses remain untrusted until the trust of such domain names or IP addresses have been established. This may allow exclusion of untrusted domain names and IP addresses, thereby preventing call-homes by malware, ransomware, and rootkits to known malware control servers.

Various exemplary embodiments may provide certain advantages, including, for example, enhancing security solutions by retrieving unparalleled knowledge of domain trustworthiness; differentiating safe IPs from untrusted IPs within the same domain; maximizing incident response efficiency by reducing domain research time; analyzing logs more effectively by enriching them with contextual metadata; and enabling self-service through a developer portal.

In general, certain exemplary embodiments may include a scalable, high-volume API configured to query one or more local or third-party data sources for the reputation of IP addresses and hostnames (or domain names). This API may be in communication with a reputation database containing a reputation inventory of billions of IP addresses and hundreds of millions of domain names A resolution API may calculate and return reputation scores and/or recommendations regarding block/allow status. In addition, an enrichment API may generate and return detailed information of the reputation of the resource. Some exemplary embodiments may also use DNS dynamic filtering to provide DNS resolution that contains multiple IP answers, and return answers deemed safe. Requests may be logged historically, and may be viewable through a cloud-based dashboard to assess the health of a client. In another variant, the search results from the local or third party reputation databases, the calculated reputation scores and recommendation from the resolution API, historical logged data, or other data above may be used as a training data set for a machine-learning algorithm.

Certain exemplary embodiments discussed herein may relate to a cloud architecture that extends the effectiveness of a global threat engine to an Infrastructure as a Service (IaaS), Platform as a Service (PaaS), Software as a Service (SaaS), and serverless resources in the public cloud. Some exemplary embodiments may serve as a protective gateway to a virtual private cloud (VPC), both providing zero trust access to, and protecting outbound connections from, virtual hosts and serverless functions within the cloud.

As an example, various exemplary embodiments may relate to a cloud, which may provide distinct layers of network protection for cloud resources. Specifically, real-time DNS protection may be provided to a VPC, powered by the threat engine and its historical knowledge of billions of Internet domains and IPs. Scalable, peer-to-peer zero trust networking may also be provided to the cloud leveraging an endpoint to provide users the capability for secure communications with an environment from anywhere in the world. Various exemplary embodiments may include simplified cloud-to-cloud zero trust connectivity for services across multiple cloud providers, as well as enhanced private cloud security, allowing access to only authorized and authenticated clients and networks. Seamless and simple data ingest may be provided for existing security infrastructures through API integration, as discussed herein.

Various exemplary embodiments may integrate with endpoints (discussed below), providing configurable zero trust network access from managed user devices to designated endpoints, such as resources within the protected cloud environment. Certain exemplary embodiments may also protect outbound DNS requests between the VPC and the public internet, which may help prevent compromises, malware, and malicious software that may be present on cloud resources.

Further, outbound DNS requests originating from the cloud environment may be inspected and protected, and may be powered by a cloud API (e.g., reputation database based on a 20-year inventory of the Internet, containing reputation for billions of IP addresses and hundreds of millions of domain names). The cloud entity may also automatically log outbound DNS requests, and provide historical log visibility through a cloud-based dashboard to assess the health of a client. The cloud may be implemented as a Linux-based container within a VPC that may provide DNS resolution services and a gateway to and from the provisioned zero trust network.

Various exemplary embodiments may relate to an endpoint that provides unprecedented network protection on-premise to remote user devices, mobile devices, cloud endpoints and virtual machines, establishing a zero trust network both for intra-organization connectivity and external Internet connectivity.

Certain exemplary embodiments may relate to endpoints that provide three distinct layers of network protection. The reputation-based threat engine and its historical knowledge of billions of Internet domains and IPs may provide a first layer of network protection by performing real-time inspection of inbound and outbound connections. Scalable, peer-to-peer zero trust networking may enable secure communications between users and environments from anywhere in the world. In addition, some exemplary embodiments may include a renderer, such as a built-in, cloud-based safe browser environment where risky webpages can be seamlessly rendered remotely and viewed locally with no risk to devices nor systems.

Some exemplary embodiments relating to endpoints discussed herein may provide internet zone protection, including inspection of outbound DNS requests and inbound and outbound IP, TCP and UDP flows. The endpoints may be powered by the cloud API reputation database (discussed above). In addition, some exemplary embodiments of the endpoints may include the ability to create custom allow and block lists tailored to the device or organization, as well as cloud-based logging for viewing dashboards, metrics, and threats.

In some exemplary embodiments, the endpoints may include zero trust internal networking, which may provide a peer-to-peer encrypted network overlay that allows users to access securely defined network endpoints via zero trust credentials; bypasses the need to create firewall appliance rules; and/or provides centralized per-user, per-application, or per-device credential management.

Various exemplary embodiments may include a renderer entity, which may be implemented as a browser plugin for common Windows, Linux, Android, iOS and macOS browsers. As an example, the renderer may transparently redirect browsing requests for suspicious or malicious sites to a cloud-based browser isolation environment where it can be viewed safely. Users may scroll, follow links, submit forms, and view content normally all within the safety of the isolation environment; save session history for navigation; and navigate back to a safe site may revert the browser to normal, local processing.

Some exemplary embodiments related to endpoints may include support for WINDOWS, MACOS, LINUX, ANDROID, and IOS devices; centrally managed per-user certificates based on generated tokens; and FIREFOX and CHROME browser pluginS for seamless transition to cloud-based renderers.

Various exemplary embodiments described herein relate to capabilities of monitoring and blocking of untrusted communications at the device level. Further, an accumulator may use remote lookups via an API to allow simple smart agents on a laptop, phone, mobile device, tablet, server, or gateway to incorporate reputation and behavior for trillions of internet IP addresses, hostnames, routes, data centers, countries and the like, which may be stored locally. These lists may be stored locally, and/or remotely and cached locally. In all cases where there may be a large remote reference database, there will often be a local database of special cases, exceptions, overrides, or other preferences for this device, network, or enclave. In many cases, the reputation lists used by the smart agent may be universal (i.e., safe or unsafe for all clients, servers, infrastructure, or IOT devices to communicate with). However, role based adaptations may represent a new class of universal rules (e.g., servers, clients, printers, IOT devices, and infrastructure (bridges, switches, routers, firewalls)).

In various example embodiments using role-based universal rules, a restriction may be balanced with solutions that preserve functionality while limiting security breaches. Thus, when clients are barred from communicating with other clients, clients cannot spread infections laterally within a network, enclave, or organization. However, a network file sharing mechanism may be provided, which provides audit, control, and restrictions, impeding lateral attacks to be launched between clients. Internet of Things (IOT) devices are generally not considered clients, and should not initiate connections with internal servers (and rarely to clients). As an example, smoke detectors, cameras, and network devices are not clients, and do not require access to corporate data, customer data, or other protected resources. In another example, a printer may be a potential source of corporate data; in particular, smart printers that function as IP fax machines, email sources, and destinations, and may function as scanners. This multitude of tasks may complicate efforts to detect and prevent security breaches from these smart printers. For example, printers may receive print jobs from clients or print servers, but then should not send data to any outside device (stealing printouts electronically) Similarly, smart TVs and other smart/connected devices in a conference room that listen for voice commands may constantly stream live audio from conference rooms and executive offices to cloud based voice recognition services. These smart devices and smart TVs may be targeted by spyware. Although some smart devices and TVs may not currently support agent software on such devices, they may do so in the future. In this case, some exemplary embodiments may be used as gateway filtering devices in order to stop unauthorized monitoring by printers and televisions. While these are some examples, every connected device may include a myriad of sensors, which can observe, record, log, sense, learn, discover, or survey private activity. It may be difficult to determine which hidden sensors or covert operations are built-in to a particular connected device. Some exemplary embodiments may leverage universal rules based on device, role, and behavior, along with the other trust-based techniques to control undesired habits that are the core elements of bad behavior.

Some exemplary embodiments may relate to a Smart Agent deployed on a client (e.g., desktop, phone or tablet, mobile device, operational technology (OT) device, vehicle, infrastructure), and related traffic. For example, with inbound traffic, because such clients are not servers, these clients should not offer services that are capable of external connections by other devices. Similarly, with outbound traffic, a reputation list may protect the client from outside connections, from outbound connections to untrusted devices/networks, and from lateral East-West connections inside the network. Various exemplary embodiments may relate to when the Smart Agent may be deployed on a server, and/or when the Smart Agent may be deployed on (or on a gateway that serves) printers, IOT devices, infrastructure (bridges, switches, routers, firewalls), and larger collections of devices without Agents (like a data center or small office).

Various exemplary embodiments may include surfing protection, such as blocks vs renderer, and back and forth. Specifically, in the simplest form of surfing protection, the smart agent may allow connections to trusted remote devices, and block connections with high risk, unknown risk, or other selected criteria. When used in conjunction with a renderer, the smart agent may block without blocking, such that an unsafe or higher risk site may be rendered on a remote renderer so that unsafe code, unknown code, or risky connections may be made only on the remote rendering machine, and viewed remotely by the local machine. Some examples may include over 5 billion hosts that are trusted and rendered locally, and over 3 billion hosts that are not trusted and are instead remotely rendered. When IPV6 numbers are counted, there are over 10³⁴ hosts that are trusted, and over 10³⁶ hosts that are not trusted and may be remotely rendered. The accumulator may be utilized on both the smart agent, and the corresponding API lookup service may provide a scalable way to look up trillions of reputation ratings and make forward/block and rendering decisions in real time. Another example may include when 100% of internet web surfmg may be done in the renderer. This may not only prevent zero days and exploits from websites from executing code on a local machine, but may extend this protection to email by the use of webmail in the remote renderer. As a result, no email attachments nor links can run code on the local machine.

Some exemplary embodiments may relate to blocks vs renderer. For example, when a safe website may be viewed on the local machine, there may be a large number of source (SRC) links, JavaScript, and other code present that open links to media servers, communicate with tracking sites, and download additional scrips, plugins, files, images, and the like. The number of these links on common news sites, which connect a client on a relatively safe news site to a mistrusted site, may average about 12%. A smart agent present on the user's workstation, server, other device, or smart agent gateway may necessarily need to block high-risk sites to protect the user and networks. Thus, if a site may be allowed, not all of the SRC links and secondary connections called by scripts and code may be allowed. However, when a site may be blocked, but may be executed on the renderer, such filtering may be no longer necessary. This means that no site will consider the renderer to be blocking ads, nor may any component of a page be blocked from the remote renderer because it cannot harm the user as it may be rendered remotely and safely. Provision can be made to allow a safe site to be rendered by the renderer so that untrusted links can also be viewed, observed, and logged for forensics.

In some example embodiments, a smart agent may include a plug-in, which may overcome certificate pinning and the redirect approach to rendering. DNS or HTTP redirects have been previously used to cause a redirect to a virtual machine for safe surfing; however, this may not work due to certificate pinning as a way to prevent man-in-the-middle (MITM) attacks. Some exemplary embodiments may use a plugin to first check if a site may be trusted or untrusted. If trusted, the site can be fetched, processed, and displayed on the local machine. If untrusted, that URL/URI may be transmitted to the remote renderer where all of the HTML code may be fetched, and SRC links may be fetched and scripts are run. This may prevent hostile or potentially hostile code from running on the local machine. The back and forth may be a process where safe things may be fetched locally and untrusted things are remotely rendered; however, there may be an ongoing process where a web surfing human can click on anything local or remote without regard to what may be safe or unsafe. The unsafe resources locally selected may be seamlessly and transparently sent to the remote renderer for viewing. Similarly, safe resources selected remotely in the renderer may be transparently returned to the local machine for processing. In this manner, bandwidth and CPU may be optimally used at all times.

Some exemplary embodiments may include color change data protection stages above default, and may include a renderer using a HTML web page motif In the variety of ways in which computers are compromised with malware, email and web surfing constitute a big part of this topic. Thus, when a user always uses a renderer to read emails, email attachment may not matter, and links to malware in the email may not matter. Challenges remain with deterring users from clicking on compromised links; users may click on compromised links given the right conditions. However, the renderer may address a wider range of threats with a wider range of solutions that have not been previously described. For example, if a user arrives at a download button on the web, that link may begin a trivial file transfer protocol (TFTP) session which then downloads a file to a local machine. With these downloads, file extensions may be hidden such that it looks like a safe file, but instead may be a document which contains executable scripts, macros, or other code which carries zero days, malware, data exfiltration, or other hostile payloads. If a computer includes company proprietary data, protected personally identifiable information (PII) data, or other sensitive information. The renderer provides the ability to separate all high risk and low trust operations to a remote renderer that may handle far more than just HTML.

Conventionally, many commonly used document types are capable of containing dangerous scripts. Thus, a PDF or WORD document found on the internet or received in an email may contain zero day threats or other malware, which antivirus protections may not address. Even simple CSV and text files, which cannot normally contain executables, may be spoofed where the link looks like CSV or text, but are actually files, which an operating system may access natively, associated with an application, and open it natively on a local system, causing a major breach.

The Renderer may be optionally configured to support remote safe storage in the renderer. In such configuration, downloads can include a form for a conference, a loan application, a trade show registration, an entry form for college, or any number of things that a person cannot just opt-out and ignore. Rather than loading onto a home computer, these files may be downloaded only to the remote renderer, and be filled out remotely using web-based applications, safely and remotely. Thus, some exemplary embodiments may create a clean and simple way to download files without actually downloading them to a computer, and instead download them to a safe storage system which may be on or associated with the renderer.

Various exemplary embodiments may relate to “cleaning” dirty files found on the internet or received by email, text, signal, or other means. This may be performed by remotely decomposing files to their lowest common denominator so that they cannot contain scripts, which may be done using a process where the user may not be involved and able to do things in an unsecure manner Thus, certain exemplary embodiments may create a way to download untrusted files from outside or inside sources, cleanse them, and transfer them to a local system. This may be necessary to import reference materials, data, presentations, and the like. An important aspect may be integration with the Smart Agent, such that the user may not make security blunders by downloading or opening the wrong thing in the wrong place. Thus, downloading and opening may be performed on MICROSOFT files, open document formats, PDFs, presentations and other file types in a remote renderer; this may allow a user to modify them, save them, and share them in a “dirty” remote environment where the files may contain malware. Then, the user may select “cleanse and bring to local machine” or “bring to a local machine unchanged but encrypted” for forensic purity purposes. Dirty files may be kept and manipulated remotely, kept encrypted locally but only manipulated remotely, or cleansed remotely and imported to the clean local system.

Various exemplary embodiments may protect proprietary or other protected data against cross contamination, independent of data exfiltration controls, as discussed below in more detail. WINDOWS and many other operating systems include flaws in their ability to audit the flow of sensitive data between labeled containers, documents, or messages. Copy and paste may cause challenges, where the audit of movement of data from a company private file to a public document may be difficult to audit or control. In some older military documents, this was referred to as color change. One variant of various example embodiments may be used to enforce color change by storage and communications filtering to protect organizational data from leaking while protecting the enterprise from outside malware.

When an organization has multiple levels of sensitive data, these levels of sensitive data can be isolated so that copy and paste can only happen between documents of the same color. Likewise, save-as can only happen to the same color. In this mode, the Smart Agent may use tagging or encryption to isolate storage to each color. At the same time, external communications may be limited to modes and connections that are limited to the same color level.

Communications between colors may be only allowed with automated services, which scan, perform cryptographic checksums, document, log, and move items up or down between colors. Unlike simple copy and paste actions, or saving a proprietary tagged file to a public file status these activities are fully auditable and controlled. The way for colors to be kept separate may be for there to be no way to write up or write down. Of these, the simplest way may be to separate the storage such that if red may be openable, black may not be openable or writable. This may also apply for communications, such as when in black mode, full internet communications are available. However, when red files are open, all external communications to non-red destinations are blocked.

Previous techniques for outbound protection may allow tracking of all outbound connections, which DNS hostname lookup preceded each connection, and the flow on each connection. Since this may be integrated into an on device Smart Agent with connectivity to a global risk and role database, a much more complete ability to detect and enrich outbound signaling and connections may allow detecting and stopping unwanted outward connections. Unlike previous network-based approaches, the correlation between DNS lookups and connections outbound may be more reliable. Nevertheless, the use of accumulator technology makes it possible to scale the solution to make local correlations, and to take instant action to stop outbound connections representing call-homes (beacons used to gain remote access/control), and just any outbound connection which may be not beneficial to the device in question. Connections may be checked for appropriateness and risk/trust.

Call-homes are a class of breach, which may be seldom monitored or stopped at the device level. Some examples cover the topic of detecting and may be the accumulators described in previous techniques cover blocking call-homes at the network level and the quick lookups and accounting and behavioral learning. As described throughout this disclosure, when implemented on an Agent, it may be known which device initiated the connection. Even in cases where the source IP may be spoofed, such as in a spoofed UDP DNS lookup from a device, the Smart Agent is hosted on the device and detects all call-homes even if spoofed. At a basic level, a DNS lookup, a ping, or any other type of communication can be used as a messenger. Previous accumulator techniques may be leveraged to monitor all outbound messages and may be used to detect short and long-term periods between call-homes. Call homes are detected by many methods, some of which include DNS lookups for which no subsequent IP connection may be attempted, DNS answers that appear to be commands rather than IP addresses, and certain timings described as triple heartbeats in previous techniques.

Exfiltration detection and mitigation may be accomplished by a variety of methods, including the detection and stopping of COVCOM for remote access and control by adversaries. Leveraging the methods described in previous techniques, which may be tracked in real time by an accumulator, communications are blocked may include those initiated by an outside party that may be from untrusted space, including blocking connections even when the attempted connection has valid credentials like a stolen username/password). This may also include communications initiated by a protected device but attempted to connect to an untrusted device, as well as outbound connections that exhibit the characteristics of robotic call homes. These may be a sleeping compromise and are the stock and trade of ransomware breaches as they serve as a constant way inside for adversaries—a landed breach awaiting hostile actors to SSH in or send instructions, malware code updates, or commands. However, the survey portion of a breach may be where defeat of call-homes may be key. Such communications may also exhibit the traits of a triple heartbeat associated with remote control of an outbound session. Furthermore, some communications may be an otherwise allowed connection such as HTTP, SMTP, TFTP, FTP or other communication which has a net outflow indicating exfiltration of data which may be unexpected and out of normal bounds. This can include backups to untrusted or uncontracted vendors including servers in disallowed countries or operated by untrusted organizations, or hosted in an untrusted data center.

With respect to file leakage protection and audits, encryption and better certificate practices are intended to stop man-in-the-middle attacks. However, data protection may be problematic since an organization has no way to know how its data may be flowing and may be the destination for such flow. In previous techniques, files may be transmitted throughout an enterprise unencrypted, so network devices could merely calculate the checksum of a file and record the destination and origin addresses for each flow. The Smart Agent addresses this problem by reaching into the host for the name, path, date of each file being read and transmitted calculating the checksum of the file as well. This affords a full audit of the sharing and transmission of files both inside and outside of the organization.

For example, the Smart Agent may hide all services unless expressly allowed, so that casually configured file sharing may be not reachable on all Smart Client equipped devices. As a result, password and weak password or zero day exploits may be prevented. Since most major breaches involve malicious code already running on a platform, outbound file transfers via all protocols may be blocked for untrusted destinations.

For all connections and protocols, the Smart Agent may connect the file access audit data to the data transmission logs. The Smart Agent may also provide that, for any operating system or communications product, “this file, with this name, this path, and this checksum was sent via this method to this destination at this time.” The Smart Agent may capture this information by creating a forensic history of the flow of all versions of all files. This may be critical to many kinds of controls and audits, but does so in a way such that the audit system does not present a security risk. For threat hunters, it may show where an infected file came from, which machine sent a sensitive file to where, etc. Encryption may be hiding the ability to secure data flowing across networks. This audit innovation may close off the mystery of file copies and file movements.

Some example embodiments may also relate to Real-time Ransomware detection and data exfiltration detection & blocking. For example, a system never touches the vast majority of files and modifies only a small portion of the tiny number of files it reads. Ransomware may read and modify some or all of the files to make them unusable to the system owner. There are some minor exceptions, such as backup systems who may use one or more of the attribute bits and may set or unset the archive bit to note files that have been modified because the last backup, but modifying these are not the same as writing over portions of a file by ransomware. Likewise, remote backup and remote theft are discernible by communicant and observation of the baseline of a device compared to the rest of the enterprise.

Various example embodiments may also relate to inbound protection. All machines have known and unknown vulnerabilities as well as services that may be enabled for outsiders to access. The Smart Agent may shroud the machine it protects infinitely, such that any device cannot access no services or even an unknown vulnerability unless it is from another Smart Agent, is with specific granting of that service or port, and/or blocks all outsiders unless specifically allowed (like a web or mail server).

Certain example embodiments may also relate to unique renderer enhancements of the Smart Agent. An element of the Smart Agent may be the implementation of a device side messaging system that may communicate with the renderer. Functions previously associated with proxies, the like are increasingly impossible due to certificate pinning, and other methods intended to prevent man-in-the-middle attacks. Some exemplary embodiments may not redirect by DNS or HTTP redirects from the client to the renderer since the render cannot provide valid certificates of the site/device that the client wanted to visit. Thus, the communication may either be blocked or made by the original client. Some example embodiments may be described as the “back and forth” operation between scripting in the client and the renderer—such that the system first determines if the communications are untrusted/unsafe, then that fetch request may be transmitted to the renderer by a method which may or may not be native to the browser but may be instead accomplished by code in the Smart Agent. The Renderer receives the request from the Smart Agent—then the Renderer makes an original request for the resource that was requested by the protected client—and it may be rendered remotely from the client and the client views the results in the client's local browser—while none of the potentially hostile code ever touches the client's machine.

This integration between the Smart Agent and renderer works both ways. When an unsafe link may be clicked on the local browser, the Smart Agent may stop it from being fetched and miming potentially dangerous code locally sending it to the Renderer. Likewise, when viewing something untrusted on the Renderer if a user clicks on a link of something trusted and safe, that link may be transmitted back to the Smart Agent for local processing on the user's browser. This keeps a user from ever opening something in the wrong window such as may be the case with remote desktop solutions and optimizes the use of bandwidth by rendering trusted content locally. Various example embodiments may be a first in simplicity and the ability to overcome certificate pinning and other ways modern systems have blocked man-in-the-middle and masquerading attacks in a simplified way to keep the local client safe. Some exemplary embodiments may minimize the risk by being more conservative and being safer rather than more precise. If something has no reputation or limited reputation, the safe choice may be better. But with certain example embodiments, the choice may be no longer “allow” vs “block” but instead to block without blocking by using the Renderer with the Smart Agent so unless something may be safe, it may be used safely using the Renderer. Note that there are at least 3 logical modes. First, the data may be kept local by blocking things that are untrusted, and allow data that is trusted. Second, the renderer may be used to allow data that is trusted, and to render data that is untrusted. Third, a partial or full bucket brigade mode may fully survey and obtain all content safely to avoid ad-blocking side effects. Furthermore, a threshold of trust and safety threshold may be increased, up to the extreme of using 100%, rendering for all internet content, scripts, executables, data, and downloads. There may also be an option to separate, clean, and unclean storage and include cleansing as an option to import untrustworthy content safely.

Certain example embodiments described herein may have various benefits and/or advantages to overcome the disadvantages of previous techniques. For example, certain example embodiments may reduce human error; some example embodiments may automatically protect if a person tries to access something unsafe, the request may be automatically checked and appropriate protections are taken. Various example embodiments may optimize use of limited resources, and optimize response times by only rendering what needs to be rendered, utilizing the back and forth described here so that requests are seamlessly passed to and from the Smart Agent and the Renderer as appropriate. Certain example embodiments may also provide an optional bucket brigade mode which fetches can be proxied through the Smart Agent, so that targeted malicious activities may be isolated and analyzed.

Furthermore, various example embodiments may leverage real time discoveries on each Smart Agent and other products based on previous techniques, and the some exemplary embodiments such that all devices immediately know when any web resource, script, executable, content, utility, application, hardware, software, or firmware component may be associated with unusual, threatening, suspicious, illegal, or otherwise sketchy behavior or even if it has a common heritage, ownership, or operational involvement with untrusted entities. Certain example embodiments may also utilize selective filtering vs no filtering. Some previous techniques describe selective filtering which may be used for protecting a device from hostile actors, where the Active Controller filters DNS and DNS answers. It may often be the case that a single DNS query produces a DNS answer that contains more than one IP address in the answer—and this list contains trusted and untrusted IP addresses that are mirrors of the same service or content. A challenge may be that the decision on which IP to use from a big list may be an arbitrary choice made by the client and if unfiltered, the user may pick the one IP from the list, which may then be blocked by an IP filter list. Various example embodiments may drop the bad/untrusted IP addresses from MX, A, AAAA and other DNS lookup types and thus the client then chooses from only trusted IP addresses. For completeness, if none of the IP addresses are trusted, the active monitor may return an NX response meaning No Such entry found, which causes the client to stop trying to reach this particular host. This protection may be hereby extended to the Smart Agent to offer new protections, which cover more cases than were possible with a single device for a network.

Moving this filtering activity to the Smart Agent in addition to the Active Controller may also provide some advantages. For example, when using the Active Controller, the differences in location of the local DNS resolvers can shade what DNS questions the Active Controller can see. For example, if the Active Controller may be between the internal DNS resolvers and the Internet, it cannot see the original DNS request from internal devices and instead only can see the proxied DNS question coming from the DNS resolver. This means that the Active Controller cannot tell which device requested the IP address for a dangerous hostname The active controller's logs therefore indicate which internal device may be infected with what APT—or which device may be beaconing what via DNS, or a host of threat hunting challenges.

Various example embodiments may also include the selective DNS filtering of IP addresses returned because of DNS A, NS, AAAA, MX or other DNS lookup types. Each of these may return one or more IP addresses in response to a DNS lookup. Some exemplary embodiments may implement a live filter on the DNS answers. For example, if eight IP addresses are in the DNS response but two of these answers are IP addresses that are not trusted, various example embodiments may edit the DNS response to include only the six safe IP addresses in the DNS answer provided to the protected device. This may be critical because computers randomly choose which IP address may be used from multiple choices in a DNS answer. In security applications where there may be first a decision about the domain or hostname (FQDN) and then a secondary decision about the IP address, connections can be blocked based on a random choice of a bad IP among a group of good ones. There are several approaches to some example embodiments.

Some example embodiments may also use DNS to allow the Smart Agent or other user to obtain trust information from which to make filter/forward/render/block or other decisions, as well as create a new DNS answer packet with just the filtered information. Various example embodiments may modify the DNS answer on the fly without creating a new DNS packet. This can be a huge advantage in CPU load and lend itself to much faster implementations, running on simpler circuitry, or running on lesser CPUs. In this approach, each of the DNS answer fields to delete are instead overwritten as text fields, so the packet length and other factors remain the same. To avoid confusion, this text field can reflect that the IP had been removed by simple text message. Certain example embodiments may also use an API for this information. An API offers some advantages over DNS for whether to block, filter, or send the protected client to the renderer. In order to include more enrichment information, the API can be extended to offer many types of labeled data and can support more rich calls and answers. Thus, certain example embodiments discussed herein are directed to improvements in computer-related technology.

Certain example embodiments may relate to IP filtering, blocking, and redirection to a renderer. A similar approach may be used for IP based blocking, trust, and safe rendering. In the DNS case, text or other fields in the DNS answer may be used to convey risk/trust/action such as pass/block/redirect/render.

Some example embodiments relate to connection history, DNS history, TTL timeouts, and interactions between conflicting threat and trust ratings. When an IP connection may be made without a DNS lookup preceding it, pass/block/redirect/render decisions are made solely on the IP address. But when preceded by a DNS lookup for which the IP address was listed as a response to a previous DNS lookup (A, AAAA, MX or other DNS lookup), there may be an interaction between the two activities that must be correlated to make good decisions.

Various example embodiments described herein may be partially based on the Accumulator, which allows local, local cloud or remote cloud tracking of the current state of DNS results in light of TTLs clicking down every second. In normal DNS, there may be a time to live expressed in seconds for each response that ranges from 1 second to 1-week maximum. (TTL-0 may not be defined). The Smart Agent (or gateway) may always see every DNS lookup requested by the device (or group of devices) it may be protecting.

The traditional way of recording TTL in seconds and decrementing the TTL every second until it expires does not scale well. Some exemplary embodiments may store the expiration time so the DNS results cache/database does not require constant attention but can instead be consulted only when there may be a subsequent connection attempted to an IP previously included in a DNS response (or in a previous connection—along with the pass/block/redirect/render/etc. action taken).

In certain example embodiments described herein, the IP addresses contained in each DNS answer are stored in a key value store with the expiration time (rather than the TTL) along with the device(s) that did a lookup of that FQDN (hostname) or domain name This table may be stored in each Smart Agent (or gateway), on a local server, or on a cloud server.

When a device initiates an IP connection, the key value store (or accumulator) may be checked to verify if the IP was contained in a DNS answer within its valid TTL. If this may be true, then the DNS reputation may be considered along with the IP reputation for this FQDN/IP pair. As previously described, there are cases where two devices connect to a single IP device, but one may be blocked/rendered while the other may be approved even thought their IP destination may be the same. This may be because one DNS lookup was for a trusted domain and the other was for an untrusted domain Still other cases exist, such as weightings and overrides for certain hosts/domains as they are hosted in various places when the results for domain and IP reputation contradict. This data caching and information retrieval method may be necessary to achieve acceptable network performance.

By moving the DNS filtering function to the Smart Agent, there may be a log of which exact machine looked up each hostname, when, and how often which can be compiled at either end of the lookup: the Smart Agent or the remote resource where the DNS or API lookup may be served. Further, this Smart Agent sees both all of the DNS lookups, all of the DNS answers, and all of the subsequent IP (and non-IP) connections. This way, a DNS call home can be detected because there may be no follow-up IP connection to an IP address in the DNS answer received. Likewise, the same may be true for non-IP protocols as well. For non-IP protocols, there are neighbor discovery protocols that are unique to each non-IP protocol as well as leveraged use of ARP and other resource discovery methods that may not be mappable to each device without this data. The sheer number of DNS lookups and answers may or may not present a real-time problem on how to manage this real time record keeping, lookup, correlation, and blocking at the Smart Agent. The Accumulator technology may be utilized in the Smart Agent to overcome these challenges, both in the Smart Agent as well as at the central lookup service that allows the lookups at scale, recording trends and history, makes DNS to IP correlations, and provides time savings on range lookups and other challenges.

This logging at the Smart Agent is not just DNS and IP connections. Certain example embodiments may include a methodical correlation of ARP and DHCP messages to device, IP and other protocol identities along with service advertisements and lookups on other protocols. Discussed below are techniques for leveraging role vs activity to control and limit breaches in the East-West or internal lateral breach space. In modern networks, there may be a lack of visibility of MAC addresses because source MAC addresses do not propagate through routers or layer 3 switches (Layer 3 on the ISO model refers to Routed networks). Visibility into Layer 2 via MAC address correlation may improve reputation and role mapping for every device on every Layer 2 segment (layer 2 on the ISO model may be bridged networks) on which any Smart Agent may be present.

In contrast with previous techniques, various example embodiments include functions for mapping MAC to IP to port on layer 2 and layer three switches are often only available via SNMP, which represents a huge burden on the network with constant polling to create a history of MAC/IP relationships. In addition, when presented with spoofing or a duplicate IP address on two devices the polling interval of SNMP often prevents an operator from seeing fast-acting changes that start and stop in less than the SNMP polling interval. When kept on a switch or exported with Syslog, this improves the situation but may be rarely done due to complexity and log bloat.

Some example embodiments may utilize an accumulator (or perhaps a simpler technique like a cache, database, or key value store for smaller lists) to keep non-bloating records of not just MAC to IP and MAC to IP to Certificate for Smart Agent equipped devices. This process will not always be purely passive in merely observing and recording DHCP and ARP broadcasts, but may involve the use of port mirroring or inline observation of unicast answers but sometimes will involve periodic or ongoing ARPs or other queries to keep current state tables for traffic attribution. In the face of duplicates or spoofing, additional logging or polling of devices will be leveraged to determine which device (of the devices not equipped with a Smart Agent or Gateway) may be responsible for the spoofing, error, duplication, or other error.

In addition to improving accuracy of traffic statistics per device, it can be used to detect and document DHCP and ARP spoofmg in which a rogue device uses these protocols to falsely re-route traffic in the LAN for becoming a man-in-the-middle. An example would include a network monitoring device configured to become a man in the middle answers all ARP requests it hears very quickly with “it's me” by answering that the right MAC address for every IP device may be its MAC address. Thus, all traffic bound for every device on its Layer 2 segment passes through the device. Some people call this “one arm” bridging. This trick mandates that the device forward all traffic onto the actual destination, but by doing so, the device may become a man-in-the-middle for all communications that accept the arp-spoof This method may also work with DHCP, where the device puts all users on a separate IP network from the organization's network and puts itself as the default gateway—thus seeing all traffic that leaves the local false LAN IP range.)

Other accounting irregularities include detecting the possibility of “dribbling,” where a device makes a connection that lasts some time longer than the duration of its DHCP IP address lease—and that connection continues with the previous IP address after a new host starts using the same IP address. In normal Netflow records, it may be impossible to know which device did what in these cases where two devices have active communications over the same time with the same IP address.

There are many examples in network threat hunting where the records are not adequate to understand who did what to whom over time. Certain example embodiments may provide definitive records for each device protected by a Smart Agent or Gateway for all time, regardless of DHCP reassignments over time. With Netflow records, all users of the same IP address are scrambled over time with no good way to link traffic to device. With various example embodiments, there may be full time 100% attribution of all traffic to each device, including IP and MAC address spoofmg, duplications, and overlaps. The same may be true for overlay networks in which IP ranges not compatible with the base network are used for peer to peer, ARP/DHCP man in the middle accessories, or NATs hide the actual source of traffic from clear attribution.

The master index for various example embodiments may be tied to the certificate of the Smart Agent, that way traffic records are not confusing when looking at DHCP IP lease expirations and new IP addresses used by the same device over time—as well as the integration and correlation of Wired Traffic (Ethernet, Token Ring, Modem, MPLS, Frame Relay, X.25), Wireless Traffic (Wi-Fi, Bluetooth, cellular) as well as other local traffic with storage network, removable and fixed drives, etc. Keeping traffic records indexed by IP address may be bad when the IP addresses are not static over time. The same may be true for correlating Wi-Fi, Bluetooth, cellular, and wired traffic from a single device—as the documentation seldom ties these all together. However, the certificate ID of the Smart Agent or gateway does tie all of these logs, traffic summaries, flows, associations, connection attempts, spoofs, and other history together to a specific device. Further, spoofmg and hiding of Wi-Fi MAC addresses may be a one-click option on many smart phones, laptops, and tablets but these same devices do not simultaneously anonymize the Bluetooth, Ethernet or other interfaces. This fact makes it easier to fingerprint devices by correlating permanent MAC addresses to vendor, device type, operating system, and other attributes to the Smart Agent certificate. Even duplicate IP addresses and duplicate MAC addresses used at the same time on the same network may provide solid attribution to actions and attempted actions.

Using MAC address for history may be also not universally a complete solution. The settings for privacy on current day phones, tablets, and other devices allow for MAC address anonymization. In threat hunting, it may be critical to detect devices that use MAC and IP spoofing for a variety of hostile purposes that are hard to distinguish from the surface privacy options. Various example embodiments discussed herein may be the correlation of spurious IP spoofing and other remote control, scanning, remote control, data exfiltration, and covert communications to IP/mac and/or device over time.

Some example embodiments may relate to malicious activity occurring in a device. With full correlation of layer 3-7 activities to the layer 2 MAC addresses on each segment, it may be possible to improve attribution, and eliminate a number of otherwise undetectable forgery/spoofing methods as possibilities.

This will become more obvious as described below as trust, permissions, and roles on a network need to be related to what the device should and should not be doing. For example, a camera hanging outside a window should not be performing queries as a bank teller or an engineer into corporate information repositories—it may be a camera, not an employee's workstation.

Another benefit of these techniques may be that DNS lookups of different domains (one trusted and one untrusted) which are hosted on the same IP no longer block more than one party when two hostnames map to the same IP address. For example, a single enterprise of just a few hundred employees may often make tens of thousands of DNS lookups in a day. Because of shared hosting, it may be common to see dozens or even hundreds of web servers hosted on a single IP address in a shared hosting facility. The probability of having two lookups like bambi.org and pleaseinfectme.com (one good and one bad) hosted on the same IP address may be rare, but may occur multiple times a day even in small organizations. For example, in the example discussed above, with DNS lookups for bambi.org (which would be allowed under rules for an Active Controller) and a DNS lookup for pleaseinfectme.com (which may be blocked) but it is unknown which internal host asked for each because it is only known that one of the two internal DNS resolvers asked the question for an unknown internal user, it may be undeterminable to identify the entities. However, because each endpoint Smart Agent sees, logs, and filters based on both DNS question, DNS answers, and IP connections there may be no longer any need to overblock to cover lack of visibility. When two different devices request two different hostnames which resolve to the same IP address for example; in previous techniques, it would be impossible to know who looked up bambi.org and who looked up pleaseinfectme.com, so when the Active Controller sees two HTTPS connections to the same IP, it can't know which to block and which to allow. The single Active Controller may be replaced by a Smart Agent on each endpoint both of which may be known.

In cases where the protection may be being done by a Smart Agent acting as a gateway, the same benefit applies as there should be a Smart Agent gateway on each Layer2 segment so that the attribution may be done by MAC address as well as IP addresses and the Smart Agent can work as a gateway to numerous devices that do not (or cannot) support a Smart Agent. In this manner, they can separate traffic by device and both keep separate logs for each device and correlate DNS answers to IP connections as well as do the same tricks for non-IP protocols to filter and protect properly.

Certain example embodiments may also involve correlation of DNS and IP connections, with statistics and behavior observation for detecting flows, behavior, behavior anomalies, communications relationships, device type, nature, role, and security issues. In addition, various example embodiments may include blocking, rendering (moving risky or untrusted operations and communications off or away from the protected device/network), and alerts based unifying disparate observations of behavior. Current state of the art in IDS and firewalls may be to block communications based on black lists that are quite small—in the range of 500 k to a few tens of millions of hostnames or IP addresses.

Various example embodiments may include techniques to maintain audits and allow real time blocking of communications anomalies. A record may be maintained of every DNS lookup made by each device and every IP answer received, and these records may be kept current by the second as DNS answers have variable Time to Live (TTL) that makes them invalid after a certain period. Each attempted IP connection may be captured and compared to all DNS lookups which are still valid for each device attempting to transmit or open a connection.

Some example embodiments may relate to traffic flow, wherein traffic flow may be a bit of a catch-all category that includes many communications. Most threat hunters are aware of data exfiltration (theft) by use of DNS. Because DNS may be universally allowed, a simple method may be to use domain generation algorithms (DGA) to send out unlimited amounts of data across millions of DNS questions. In this breach, a hostname like “3ndnkin93mkKin.badguy.org” may be a DNS request; this lookup delivers the data “3ndnkin93mkKin” to the DNS name server of baseguy.org. Because the DNS supports 256 characters, the prefix may be 244 bytes on each DNS lookup and it can be encrypted. A massive outflow was found, terabytes of data stolen by use of NTP (network time protocol) requests as a covert channel outbound from a victim. Certain example embodiments may tie together behavior, attribution, process, source, owner, for every packet to and from every device in a network. In today's environment, if a massive outflow in traffic logs is discovered, there may be no history to follow to determine what was lost unless data in discovered in someone's possession, or for sale sometime later. Some example embodiments may trace the source of the data, and it may be important to tie the essential nature of dynamic protocol behavior into expectations. Endless DNS outbound requests where the entropy of the questions may be high may indicate exfiltration of encrypted data, where low entropy may indicate a dictionary mode command and control covert communication in progress. The nature of DNS may enable a connection so DNS lookups that never result in an attempt to connect may be an alert. Likewise, hard coded IP connects without a DNS lookup are also rare and worth understanding for detection of suspicious activity. Further, DNS questions that result in an answer (an IP or CNAME), which may never be pursued or connected to may be either data exfiltration, a call-home from a compromised device, a software/firmware call-home to see if there may be a new update available, or simply a web browser pre-fetching data. The connection of network activity to system activity that made the connection request may be important. In traffic flow, explainable and unexplained flows and automated security blocking may be targeted at blocking unexplained communications, especially ones that exhibit other alerting characteristics. Explained flows would contain connections to all of the tethered services and suppliers of software/hardware on a device, plus live feeds, chats, VOIP services, remote monitoring services, and many hundreds of thousands of other examples. But unexplained flows may contain all unknowns and variants of knowns which are alerting, such as a requested video service having a large amount of inbound video, but also including data uploads from an end point, which could be data theft under the cover of a video feed.

Some example embodiments may use the Accumulator technology as a way to track communications in real time, reputations, and decisions about whether to block, pass, render or alert on each connection and cache those for instant recall on subsequent packets. This approach may uniquely scale to enterprise and global scale communities, and allow this status to be kept in the cloud supporting millions to billions of devices and trillions of connections. However, in some cases, storing or caching of this data on an endpoint may be possible using Key Value stores, databases or other technologies.

Various example embodiments may include a bucket brigade mode, wherein a hallmark of sophisticated targeted attacks and malware may includelP, location, sandbox and VM aware. When the Smart Client forwards a request to the remote renderer, that remote renderer then fetches the requests using the data center or remote renderer's IP address space. For targeted attacks, this remote fetch from the renderer may no longer be at the target victim's location or IP address, so little can be learned because the attacker will likely stand down and not offer exploit code or procedures for forensic examination. In bucket brigade mode, the Smart Agent fetches all content for the Remote Renderer as described in previous techniques but does not process it. Thus, it may be similar to a bucket brigade, where the fetched content may be fetched one component at a time and relayed to the remote renderer as described in previous techniques for execution and rendering. In this manner, the adversary sees all of the fetch requests coming from the intended victim, but none of the processing or rendering of the content may be done on the protected client's local machine.

Some example embodiments may include several basic modes of operation in different situations. First, a renderer off operation may apply when the smart agent forwards the DNS lookup to an API or DNS lookup service in the cloud, which replies with an answer to block or allow each communication. In these embodiments, the DNS may lookup whether specific hosts or domains are either trusted or not, so the first level answer may be to allow or block the domain or host. For a blocked hostname (FQDN) or domain name, the DNS answer provided may be an NX (no such domain) answer. When an IP connection is initiated, a DNS or API call may be made to a lookup service in the cloud, which replies with an answer to block or allow connection to that IP address.

In situations with mixed results, various example embodiments may create a real time filtered DNS response to the actual client by doing a real time deletion of IP addresses in the DNS response if one or more IP addresses in a DNS response are “approved” or safe. This filtering may generate a new DNS packet or cleverly modify the response packet in real time by overwriting UDP DNS packets in the fields where a blocked IP address previously occupied by replacing that A, AAAA, MX or other response type with a Text field containing the same number of characters as the original IPV4 or IPV6 address that was removed.

Various example embodiments may include a renderer on mode, wherein the smart agent forwards the DNS lookup to an API or DNS lookup service in the cloud, which replies with an answer to remotely render or allow each communication. This may be a seemingly simple but complex decision tree. In this case, DNS lookups of specific hosts or domains are either trusted or not, so the first level answer may be to allow the local machine to fetch and process the requested connection if trusted or if it may be not trusted, for the Smart Agent to forward the request to fetch, process, render the domain, host or IP at the safe renderer. Thus, any host or domain name that may not be trusted may be forwarded to the remote renderer for DNS lookups, chasing down the CNAME and other redirect chains. Likewise, all dependent fetches of a blocked domain are processed on the safe renderer, including those deemed “safe” or trusted.

Unlike local processing of safe sites, in which unsafe SRC links, HREF links, or instructions contained in scrips which might be blocked by chained decisions about domain names, hostnames and IP addresses at the renderer, all contents are fetched and rendered because this may be done in a safe, sandboxed, isolated, and monitored environment. This means that locally rendered sites will not include malvertising and the redirects of javascripts ancillary to the otherwise safe site. Nevertheless, if unsafe content is being accessed, there will be an option to fully remote render a trusted site for completeness needed by analysts, threat hunters, researchers, etc.

Certain example embodiments may include a back and forth mode, wherein the Smart Agent may include functionality defined as a back and forth mode, whereby if the renderer is used, and the data is being processed remotely in a safe environment if selected or a new source is selected which may be deemed safe or trusted, that fetch or resource request may be transferred back from the renderer to the local Smart Agent for processing. This may prevent the user from clicking the wrong link in the wrong window as it may be with remote desktop solutions, wherein opening a known infectious link locally by mistake can infect a machine and organization with a zero day or other exploit. Conversely, if a user uses the renderer to browse a dangerous site, and clicks on a safe YouTube video for example, that request may be transferred back to the local browser after an API or DNS call from the Renderer and local Smart Agent confirms it to be safe.

Some example embodiments may include a bucket brigade off for untrusted requests, wherein untrusted sites and IP addresses, dangerous source links, script based calls, and other calls from a page are fetched by the safe render, which can be anywhere but for this discussion let's consider that the safe renderer may be in a remote data center.

Various example embodiments may include a bucket brigade full on mode, wherein all pages, source links, scripts, all content may be fetched by the protected client, but only processed/parsed on the renderer. This mode allows discovery of targeted ops against a person or organization. It also may be the only way to discover websites and advertising that does any targeting by comparing results between multiple devices which show various cases of targeting or none.

Certain example embodiments may also include a bucket brigade at the margins which may be a variant of the full on mode discussed above. This may prevent ad-blocker warnings and content shunning by fetching and fully processing advertising, source links and scripts that would otherwise be blocked. This could be used in any mode, including for safe sites which are processed locally on the protected client because only in this mode are unsafe source links, fetches from scripts, and other links that are untrusted blocked. With the increasing number of active ad blockers used by content providers, users have an unfortunate choice of getting the news or being infected by malvertising. With bucket brigade at the margins, the local machine would pass the unsafe links, DNS lookups, and other unsafe items to the renderer for processing. In some cases, the fact that requests would come from two places it may be necessary to switch to bucket brigade full on mode to be safe and not be shunned for blocking unsafe components.

Various example embodiments may include a code call home bucket brigade modes, wherein all of the bucket brigade modes leverage what an adversary might do to change behavior based on targeting of a user. If code is run in a lab or in a sandbox at a data center, it may be obvious to an adversary that their hostile code did not make it to a network. The bucket brigade mode may be used to fool an adversary into believing they are on a sensitive network. In this mode, a physical or virtual machine may communicate through a network as if it was there, so all of the IP communications may source through a network, but still be fully isolated and prevented from reaching, communicating with, interacting with, passively observing, or actively harvesting from an environment. This mode may place code in a remote data center (or any facility) but convinces the code it may be on a network.

The Smart Agent may also support the reverse case, where the Smart Agent provides the shrouded machine with a DHCP, ARP, and other environmental components which are unknown to a network—effectively teleporting it to a remote, fully functional public face. This may be necessary for many operations, where data is needed that may be regionally filtered, but a data center should not be located, plus many cases where reverse targeting might be a concern. This mode may place code in a network or data center (or any facility) but convinces the code it may be somewhere else. Communications with local devices are done through cut out reverse proxies to maintain the genre of being somewhere else.

Although described as a browser solution in most of the narrative, some previous techniques describe other protections for applications other than HTTP as well as for downloaded files and applications. Downloading of PDF files and forms, Word documents and many types of content may be protected in the Renderer. One of the major issues may be that modern office documents are too extendable and support a variety of macros, scripting, and other embedding options that allow malware to be covertly inserted in files and documents. This protection follows the description of some previous techniques, whereby untrusted files may be best kept and used remotely from the user on the device that some previous techniques describe as the Renderer. In future iterations, this may be remote or local to the protected device, but the key attribute may be that the system may be protected such that malware may be fully isolated. This creates a clean and dirty storage setup whereby files downloaded from the internet or received on external emails may be kept on a dirty file system. This way, a remote editor in the Renderer can be used to fill out forms and submit them without ever having to run them on a local/protected device. Some previous techniques describe an automated process which can cleanse these dirty files into trustable forms, so that they can be transferred from dirty to clean storage. Alternately, forensic copies of the originals can be encrypted and brought to the local system for evidence preservation while being unavailable to infect the local machine by being encrypted such that they are no longer accessible by the clean system. Separately, there are large classes of executables, which arrive in compiled form from untrustworthy sources globally such as applications that decrypt files for use. Many of these are large, copyrighted databases that are both essential to an organization and represent likely back doors to internal IT systems. These belong on a remote Renderer, so that a user can view the content remotely and use safe methods to import that information for local use.

Some previous techniques describe other modes dealing with clean and dirty storage, whereby sometimes it may be necessary to download likely hostile executables and potentially malicious content for archival, research, prosecution evidence, normal course of business, or other purposes. These can be kept on a separate, remote dirty storage network and viewed with safe tools in the Renderer as opposed to on the protected user's devices. Some previous techniques cover modes for preserving chain of custody with these dangerous files by keeping a copy locally but need a way to prevent being compromised by them. One safe way to implement this may be to encrypt dangerous files with public key cryptography with a system that prevents the private keys from existing on the clean networks. In some circles, this may be similar to red-on-black or black-on-red methods where two worlds can coexist with each other but not interact or cross contaminate.

East-west or lateral protection inside an enterprise. Inside corporate networks, there was almost no facility to watch or stop internal attacks a solution for this challenge uses hardware at the switch level to tag traffic and provide protection against spoofing and a central controller to block or allow traffic between all internal devices in a network.

Previous techniques describe an enclave mode in which devices are isolated from each other using one of several techniques. The simplest of which may be the use of port level VLAN tagging such that every device on every switch port may be on a different VLAN than all other ports on each Layer 2 network. Using the method described in previous techniques, no two devices on the network can communicate at all until a central controller changes the VLAN tag to allow communications to happen. The other advantage described in previous techniques may be that all traffic must pass through this “active controller” between any two devices that also provides traffic audit visibility for all communications as well as attempted communications. This setup allows easy detection of spoofmg of IP, MAC Address, and other credentials by tagging based on device and port.

Previous techniques were in contrast to the current state in modern switched and routed networks where there are huge amounts of communications which never pass through a device that may be capable of recording, watching, or controlling communications. Thus, any infected device inside a network can scan, probe, and launch zero day or brute force breach methods against other internal devices. In this way, devices are mapped to ports and things like MAC and IP spoofing are easily detected and blocked. These methods are incorporated by reference into some example embodiments but extended by the innovation of the Smart Agent that offers a more complete implementation of the concepts with potentially fewer setup complexities.

Various example embodiments enable the creation of a Smart Agent that allows both watching/logging and stopping internal attacks (also called East-West or lateral attacks) by software. Additionally, it protects against East-West (inside/inside) and North-South (outside/inside) both on physical and virtual networks. Virtual networks may refer to enclaves which are not like a traditional enterprise in a building, but instead virtual enclaves made from individual devices which are distributed widely, at homes, mobile, anywhere.

Certain example embodiments may implement the benefits described in some previous techniques, but does so at agents on (or inline with) endpoints instead of using hardware and a central controller through which traffic may be controlled. Compared to some previous techniques, this improvement may reduce installation complexity, reduce cost, and increase throughput while achieving the characteristics and claims described in some previous techniques.

A improvement from the prior state of the art may be to make allow/disallow decisions at each device based on global reputation for all North-South connections. What makes some exemplary embodiments necessary may be the sheer size of the challenge may be much larger than can be practically stored on servers, desktops, laptops, mobile devices, other devices, and gateways—because decisions about what to allow and what to protect against number into the billions for hostname/IP pairs and IPV6 allow lists number about 10³⁴ while the IPV6 distrust list may be currently about 10³⁶ power. Some exemplary embodiments may equip each agent with a lookup of reputation for each new and ongoing external connection, so that safe connections are allowed but untrusted connections may be either safely handled or blocked. This safe handling for web and other sites that are untrusted may be to utilize the Renderer described in some previous techniques. So the smart agent on a mobile device (iPhone, Android, iPad, android table), laptop (MAC, PC, or Linux/Unix), infrastructure device, IOT device, networking device may be for the first time armed with reputation, function, and ability to control/block/render safely all connections based on a wide variety of knowledge which may be kept up to date.

In some example embodiments, the massive reference databases and history may be included in these agents by leveraging remote lookups as well as local caches to enable distributed agents to and for devices incapable of uses an agent (or another device inline with the traffic flow) to enable authentication, monitoring, control, tagging, encapsulation, auditing, securing, and understanding communications and attempted communications.

For example, the presence of an agent on a device allows more visibility, audit, and control than may be possible with either host based or network based security measures used separately. This may be true from many perspectives when one regime may be used to fill in unknowable gaps between the internal processes on a computer, network traffic, spoofing and other masquerades, and the authority/entity/human/automated process that drove an observed activity.

Various example embodiments may include various roles and permissions. Previous sections discussed of moving some exemplary embodiments accumulator technology, the enclave protection, and the renderer protection to a client or local gateway to protect devices that cannot support a client. Some example embodiments address the problem of outbound call-homes on security with the global supply channels of today and the ongoing plague of zero days; there may be a back door into one or many devices on each network, enclave, or device.

By moving the accumulator technology to the Smart Agent, various example embodiments may add detailed independent audit of communications, relationships, and many other items to each protected device. This may provide attribution and full time accountability of behavior and behavioral anomalies at the device level. By allowing cloud, local cloud, and local caching of master databases of global and local devices with function, manufacturer, role, history, behavior and trust—the control may be based on much richer data and be enforced on every packet, flow, and relationship.

By implementing an ability to realize the goals achieved for a physical enclave for virtual enclaves and individual devices each device with a Smart Agent or Gateway can have a higher degree of security, audit, control, and adaptive protection whether at work, mobile, home, or anywhere.

Some example embodiments utilizing a Smart Agent may remove the barriers imposed by Certificate Pinning and other measures which may prevent redirection of unsafe web and networking interactions, so that the Back-and-Forth described in some previous techniques, and this document may be functional and seamless for web surfing, direct calls, and making the use of untrusted resources safer with the use of the Render methods described in some previous techniques.

Various example embodiments may provide Role and Certainty based Protection. Some techniques may use certificates and cryptography in clients, gateways, and servers to create and enforce closed communities. In such a model, an administrator can pre-describe and enforce rules on who can access what in a closed community. However, where certain example embodiments may improve the industry may be in controlling the communications both inside and outside this closed community based on role, risk, trust, behavior and many other factors.

The use of certificates on a device to grant and deny the ability to communicate within a closed community may be public domain. However, adding role, device type, function, and binding these to the cryptographic certificate may provide certain benefits. This may enable creation of a multi-tier hierarchy of trust, role, and information domains that are innovations that have been needed in security.

Some examples may begin this process based on the requirement to discover, log, catalog, learn, conclude, and take real time actions based on devices, users, role, traffic, associations, and other activities seen within a closed, semi-closed, or open community of devices. In some previous techniques, some of the foundations of this approach with examples of physical attributes of a device which can be learned locally, but not observed remotely in a virtual enclave where trust and risk need to be understood and used as a basis for not just binary permissions but instead to identify, quantify, interpret, alert, alarm, and act in a variety of contexts. The simple foundations of using MAC addresses and local observations of services and activities confirm what a device is, what it does, and bucket what may be should and should not do. Some embodiments describe techniques to encapsulate local knowledge and communicate this remotely. Certain example embodiments may integrate this knowledge with some exemplary embodiments global trust engine based on the accumulator technology and the role based correlations with a distributed base of appliances, Smart Agents, gateways and other network devices which can use out APIs to all contribute to and get results/knowledge back on all devices both inside and outside their networks, enclaves, virtual enclaves, data centers, cloud instances, private networks, public networks across IT, OT, telephony, transportation and any type of network or even isolated devices which are meant not to be connected or networked. The following role based protections are part of this technique.

Servers (whether local, corporate, or cloud) should not initiate communications, and may be easier to secure against data exfiltration and unauthorized access using call homes; since they are not clients, they can be prevented from initiating outbound connections.

Servers should respond to clients. If the server is not public, it should only respond to authenticated clients that are cryptographically confirmed to be part of the private enclave authorized to use the resource. Servers are not clients: they should not surf the web. Servers are not initiators; they should not connect to devices and start exporting data.

Servers have some roles in which they are clients: they need accurate clocks to support secure communications and more, and may be NTP clients. They may initiate backups, RSYNCH, and other functions, but these may be consistent and understood.

This may be a clear example of the need for cryptographic authentication and protection using zero trust principles. Servers are clients for updates for software and firmware. They should not request or respond to updates, API data, or connections incongruent with their type, function, make, model, firmware, operating system, applications, and services. Servers sometimes have API calls to other servers, which may be a client-like activity. Clients can talk to servers. They are the hardest to protect because a client can potentially talk to anything in the world.

This may be a significant security risk in networks, whereby any client on a network with authorized or unauthorized access to private data can potentially store and forward that private data to any device internal or external to the organization.

Methods for audit, monitoring, and selective control of all communications may be hereby applied to Smart Agents and Smart Gateways that can protected servers, clients, networked devices, IOT devices and others at the device level. These may be static rules based on trust and risk, as well as dynamic analysis partially based on the Accumulator technology which allows real time detection of data exfiltration, COVCOM, remote control, and other messaging which may be inconsistent with expectations, history, role, risk, and other factors.

Clients have exfiltrated data using DNS, NTP, HTTP posts, FTP, Mail, chat clients that may exfiltrate data using many protocols that involve transmitting packets, copying data, or even sending data to a local device can be used to transmit RF.

Some examples cover the renderer, so that a client may be protected from accessing untrusted resources and “block without blocking”. In this manner, the client may see any page on the web without every actually touching it or running untrusted content locally. However, devices that are used for dropboxes, data exfiltration, or remote command and control for malware/spyware can be mitigated using the Renderer. This may be because the interaction with untrusted internet resources may be not between a protected machine and the untrusted resource—but instead between the Renderer and the untrusted resource. The renderer is not merely a way to deal with web surfing to dangerous websites, but offers protection and analysis for FTP, video, audio, documents, executables, scripts and provides a remote, virtual, or armored safe zone for these activities. Some previous techniques also describe dirty vs clean storage and processes to decompose unsafe file types into types that cannot contain executables and other malware.

Clients are not servers with a peer-to-peer connection between two clients it may be a potential sign of a lateral breach or of file sharing peer-to-peer (which may be done another way to stop lateral breach spreading).

Although it may be common for Windows Computers, MACs and other devices to support peer-to-peer file sharing this may be also the mechanism utilized by bad actors to accomplish lateral spread inside a physical or virtual enclave, whereby a single infected machine can spread the infection or compromise to other machines within a physical or virtual enclave/network.

Some example embodiments may be a file sharing service built into the Smart Agent (or gateway) which provides the served virtual community with an alternate to peer-to-peer file sharing. Various example embodiments may stop lateral spread inside a network by a hostile player by turning off the methods bad people use to spread laterally. In this mode, normal peer-to-peer file sharing methods are blocked and peers have public and private virtual drives in which they can post files for others or copy files into other's virtual drives inside an encrypted enclave. Certain example embodiments may bundle several features that make the network more secure and keeps the files more secure at the same time. By providing an alternative to peer-to-peer file sharing which may be certificate based and inside the closed community, there may be no uncontrolled path for an infected machine to infect laterally in the East-West direction (internally).

Some example embodiments may also include auditing allow file sharing, while knowing what was shared laterally between users; controlling cold stop all internal scans, remote login attempts, stop peer-to-peer file transfers, etc; preventing all internal connections from unauthenticated devices not equipped with certificates, audit, and other controls; and scanning, converting, and making files safe as described in some previous techniques or per policy.

Various example embodiments may include file privacy closed loop system, with audit of raw files transferred, but without weaknesses exposing sensitive data to outsiders, including elimination of 3^{rd} party relays and hosting. Accounting and consequences of sharing malicious files in a closed community, those that share malicious files can be isolated from the service or forced to pay for 3^{rd} party file passivation per some previous techniques. Certain example embodiments may include crown jewel vaults vs hallways and infrastructure.

Servers and clients are where important data is stored, viewed, created, curated, updated and shared. This may be the group of devices that should be protected with Smart Agents for a number of reasons. Using certificates and the associated cryptographic underpinnings, all of the clients and servers may inherit a host of security advantages from the Smart Agents and gateways not available otherwise.

They can be configured become invisible to all devices not equipped with Smart Agents or gateways. This means that all IOT devices, TVs, cameras, thermostats, routers, switches, hubs everything not part of the club authorized to hold, process, view or manipulate confidential data just can't see or connect to devices which can. All ports, services, and zero days native in platforms will be hidden by the Smart Agent so they essentially have an infinite firewall in front of each device: on the wired connection, on the Wi-Fi, on the Bluetooth, and on the cellular. This further means that if somebody knows a username and password or steals a 2FA device, they cannot log in from any device not equipped with a Smart Agent. Nor can they spoof their IP address and MAC address and get past filters. They simply cannot get in to try their stolen credentials.

All data connections and control flows are encrypted independently from any underlying encryption present so if an adversary penetrates applications and negotiates for a weaker encryption algorithm or a weak key, it doesn't matter because the Smart Agent encryption overwraps all communication internally even when any or all devices are at the office, home, mobile or cloud based.

A closed virtual enclave, where those devices so equipped can reach any device and those not equipped with a Smart Agent or Gateway cannot breach security. This means that if one of servers, laptops, phones, and tablets are compromised via an exploit or zero day, they cannot connect to any device outside the virtual enclave, even though they might be on a network. This means that they cannot dump secrets, cannot talk to their command and control servers, and cannot get malware upgrades.

With some exemplary embodiments of the renderer from some previous techniques and the previously discussed ability to safely render content not trusted (or to not trust any internet site and render 100% of communications outside a virtual enclave) some example embodiments may provide the option to stop the import of code, ensure that content may be made safe during import per the methods described in some previous techniques and in this document.

Some example embodiments may include trusted tunnel firewall functionality. If a corporate location or a data center has a mix of Smart Agent devices, some behind a Gateway, and some uncontrolled devices there may be a gateway function that checks every encrypted connection against the list of current secure connections arranged by the connection manager. This way, it may be impossible for a device to masquerade as a Smart Agent or Gateway making unauthorized and unaudited encrypted connections to sneak data out of an administrative boundary.

Various example embodiments may include switch port validation. In a number of scenarios, it may be desirable to differentiate between authenticated devices and unauthenticated devices on a network. An API allows a switch, gateway, or firewall to correlate all connections with those that are validated as belonging to validated certificates and sessions. In this manner, IOT devices and other networking devices that are not members of the closed community of certificated, authenticated, and authorized connections to be identified. A variety of control and mapping schemes allow the security administrator to usher all communications from this group directly to the internet, to prevent them from communication with other unauthenticated devices, or in some cases prevent them from connecting to the internet except for limited and necessary services, like NTP.

Certain example embodiments may include protections afforded to Smart Agent, gateway functions, sumps, and other device classes, as well as a network composed of a mixture of devices in data centers, cloud, offices, homes, and mobile.

A Smart Agent can be loaded on cloud devices, servers, services, desktops, laptops, and mobile devices. A Smart Agent can also be loaded on cell phones (ANDROID, IOS/APPLE, LINUX, etc.), tablets, laptops, desktops, and other classes of IT devices. It can also be loaded on OT devices used in process controls, factory automation, power, telecommunications, vehicles, sensors, satellites, aircraft or anything that needs protection. When equipped with a Smart Agent, each device may have a unique certificate assigned to it alone, and may create encrypted sessions for all internal management connections, using zero trust and best cryptographic practices, such as having a new session key for all communications, unique to each pair of communicating devices for each session. The Smart Agent may also be configured to disallow all connections inbound from all devices on all ports (infinite firewall to protect against zero days), or may accept connections only from other devices which also have a Smart Agent and are currently in a group allowed to communicate with it. The Smart Agent may inherit all of the attributes described above for clients, servers and other types of devices; thus, some example embodiments may be a new ecosystem which makes some bad things less easy for an adversary to provide north-south protection (inside-out, outside-in). Every Smart Agent looks up every connection for trust and blocks unsafe connection attempts both inbound and outbound. Servers may be protected by not allowing them to connect to unnecessary external resources since servers are not clients and do not surf the web, so malware already loaded on a server may be prevented from calling-home for instructions or to exfiltrate data. Clients are protected by being protected from known bad sites as well as sites not trusted using the “block without blocking” nature of the Renderer described in various example embodiments. In this manner, a client may view every internet site but not actually touch it directly. The Renderer may use a web resource to fetch, render, and allows normal operation except get infected because the dangerous code, scripts, and content never touches a network or machines. This makes a new dynamic in networked ecosystems where reputation and behavior may be utilized at a massive scale to control and prevent connections that can harm a user, transmit data covertly, or serve as covert communications conduits for adversaries. Many compromises of networks are from stolen credentials and reuse of session cookies and tokens and other tricks. It may be a use of big data and filtering on the order of an allow list exceeding 10³⁴ and a block list exceeding 10³⁶ entries that now allows this size of reference database to protect against stolen credentials from places users should never be from. For private servers, even this will not be a problem because nobody can log in from anywhere without a valid certificate and a coordinated encrypted session from inside the closed community. Therefore, the only time the big lists and global reputation comes into play may be for public servers. A good architecture is recommended to be used, such that VPN access to a corporation should never be on a public server in the first place, but instead may be fully protected with Smart Agents on all VPN mobile or remote devices. Using the Smart Agent on VPN gateways may prevent use of stolen credentials, session twinning, and a host of other compromises.

Various example embodiments may also provide East-West protection (protection against lateral attacks and compromises within an organization or virtual enclave). A previous section describes a technique to leverage device and role as an internal security control. Starting with just clients and servers as two master categories, one way to reduce East-West internal spread of compromises may be to enforce the roles of these two groups. There are exceptions, but understanding starts with simple principles, including that clients can't talk to other clients, servers can't initiate sessions with clients, and servers don't surf the web. Furthermore, clients and servers cannot communicate with outside devices that are not highly trusted (otherwise the Render may be used), cutting off call-homes used by adversaries to command and control East-West surveys and attacks.

Data exfiltration can occur by relay between devices and exfiltration by a variety of devices. Because all Smart Agent devices have protection against exfiltration and COVCOM, along with enhanced network traffic controls, gateways can fill in the gaps for devices that do not or cannot be equipped with Smart Agents.

TVs in offices and conference rooms represent one of the very best ways to spy on meetings. With “always listening” speech recognition, their job may be to digitize and send all audio in the room to a data center somewhere—to a process that listens carefully for a phrase meant to send voice commands to the TV. Some exemplary embodiments of logging all DHCP, ARP and communications allows finding streaming voice leaving a place. This can be stopped with a Gateway.

Various example embodiments may relate to printers, which print, scan, scan and email users their scans, or email the scans to customers. They are IP connected to internal devices and external devices.

Devices like these generally do not allow Smart Agents to be loaded. The Gateway functions of the Smart Agent allow remote access to printers and conference room TVs, but simultaneously allow them to be banned from originating or responding to external connections.

Secondary innovations leveraging Smart Agent authentication combined with the visibility and control. Switch port controls may be based on device, role, and trust. It may be beneficial to identify and segregate devices by function, trust, and risk on networks. Smart Agent based devices are already isolated from a network and are easily identifiable in traffic using an API. Most organizations and home offices do not have multiple networks for trusted and untrusted devices; they all feed into a common switched environment that leads to the Internet. The methods described in some previous techniques describe a way to isolate LAN traffic by the use of Switch VLANs, which may be made much simpler. This may be because corporate activity may occur on a separate Certificate based, encrypted, protected virtual enclave using Smart Agents as a strong isolation and identifier. Because DHCP and ARP monitoring may be built into the Smart Agent, there may be another layer of detection against devices that are part of a network try to insert themselves into conversations or transactions. They should serve, but not interact with protected devices. Some exemplary embodiments put pieces together to provide both alerts and methods to isolate them from further attempts. A good security upgrade may be to isolate all of the unprotected IOT devices to a default VLAN that cannot talk to corporate servers, printers, desktops, laptops, tablets, phones and other resources/devices. The Smart Agent gateway or Active Controller may serve this function to prevent sumps from forwarding their sensitive data. Further, all of the rest of the infrastructure devices like switches, routers, smoke detectors, thermostats, cameras have no business connecting to IT devices that house sensitive data. These can connect to devices with Bluetooth, Wi-Fi, wired connections, RF, and acoustic so these are also monitored for both unauthorized connections to core keepers of data (Servers and Clients) as well as limited in their data exfiltration.

The Smart Agent protects clients by disallowing inbound connections, preventing east-west compromises from internal sources. The Smart Agent protects servers by disallowing inbound connections to ports and services that are not specified and further restricts access based on certificates and permissions from other Smart Agent equipped devices. The protection afforded clients can be set to infinite Servers need to be accessible on their respective services (mail servers, file servers, NTP servers, DNS servers) to function. However, clients do not serve, so there may be no need for them to accept connections from any device which stops most East-West lateral spread compromises cold. For servers, the Smart Agent offers the same high protection against attacks that exploit zero days and undocumented services which are not armored.

Products based on previous techniques protect devices at offices and data centers by using massive data sets and zero trust principles to stop outbound communications from malware; stop theft of data by disallowing communications to untrusted devices globally; not allowing inbound communications that don't make sense as legitimate, so even stolen credentials can't be used if they don't come from places that are legitimate places employees and affiliates can be; and protect against malicious email, messages, and websites without the downside of blocking access to content.

Employees may need these protections when working from home and traveling. Individuals who are not part of an organization may need these protections as well. Protection may always be on and working whether Cellular, WiFi, Bluetooth, or any other LAN or WAN technology is in use. When a device connects to a public or private WiFi, or a public or private wired network, pinging, probing, and connecting to a device may be prevented.

Firewalls have rules on inbound, but rarely any rules on outbound. A device may be unable to send data out silently Communications forensics may be enabled such that a phone, tablet, home controller, desktop, laptop, car, airplane, server, printer, camera may be continuously monitored and protected against outside-in attacks, lateral attacks, and in cases where the device is made in countries by companies that aren't loyal to my goals of privacy and security will be shrouded so that they will have a very hard time trying to betray trust. In addition, logs may be created for prosecution or at least making others aware of what was done.

Apart from rules and reputation, a device may be impervious to most bad things using simple, understandable rules. A phone, tablet, laptop, desktop and many other devices may be clients, not servers, so there is nothing that should connect to them. These devices may not have services that they advertise since they are not servers. Zero day exploits may include penetrating systems with over-the-wire compromises. A Smart Agent may make it impossible for any device with any new trick or zero day to touch, sense, probe, or talk to a device.

Some example embodiments may prevent ransomware spread and malware spread with a company, home, enterprise, organization, or association. If there can be no peer-to-peer communication between clients, most East-West lateral infections may be stopped before they spread.

Bolt on protection may close unknowable holes in an operating systems and hardware, by essentially creating a bidirectional firewall that only allows desired services on servers to be accessed by trusted devices.

If a foreign-made device has back doors already installed from the factory or gets back doors from updates or apps or other campaigns, the device may be part of a risk network which maps the entire Internet by use, risk, and trust.

Protection may be provided for cloud servers since it may be unclear what adversary has a server on the same machine as a cloud server, and instrumentation cannot be added to somebody else's data center in the cloud. Maximum control and visibility of all communications to and from cloud resources may be possible, and auditable access logs that are compatible with the major cloud services may be possible, both dedicated and virtual and elastic which scale with data loads.

Printers, projection displays, and other shared resources may be protected and available for all local and remote employees using the same encryption and protection as the Smart Agents on devices, servers, and cloud devices, including devices that cannot run applications by use of a compatible gateway device.

When all devices that process private data to an organization are connected by secure and audited communications, some example embodiments may detect and stop encrypted communications for which an organization has no knowledge or involvement, such as encrypted outflow of secrets, proprietary data, or other data which requires protection.

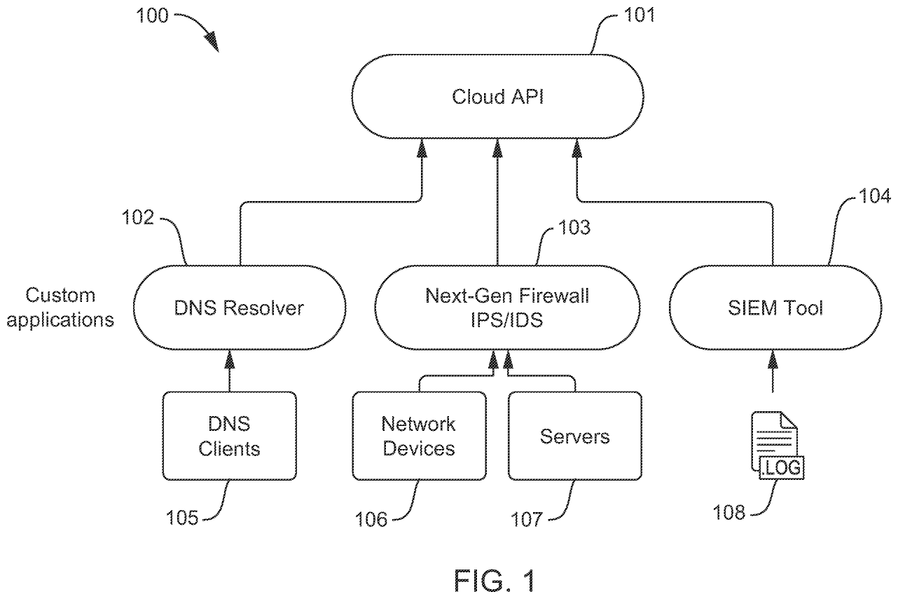

FIG. 1 depicts environment 100 including cloud API 101 that may be in communication with DNS resolver 102, which may be configured to receive information on DNS clients 105. Cloud API 101 may also be configured to communicate with security information and event management (SIEM) tool 104, which may be configured to receive logs 108. In addition, cloud API 101 may be configured to communicate with firewall intrusion prevention system (IPS)/intrusion detection system (IDS) 103. IPS/IDS 103 may have communication access to a plurality of network devices 106 and/or servers 107.

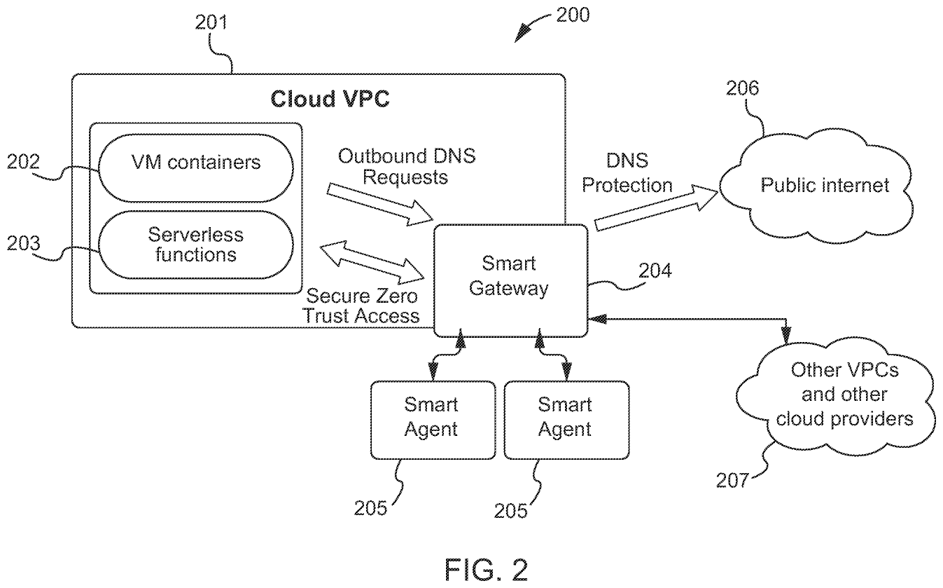

FIG. 2 illustrates environment 200 including cloud VPC 201, which may include VM containers 202 and/or serverless functions 203. VM containers 202 may be configured to transmit to outbound DNS requests to smart gateway 204, which may also exchange secure zero trust access with serverless functions 203.

Smart gateway 204 may further be configured to communicate with any of at least one smart agent 205, public internet 206, and other VPCs or other cloud providers 207.

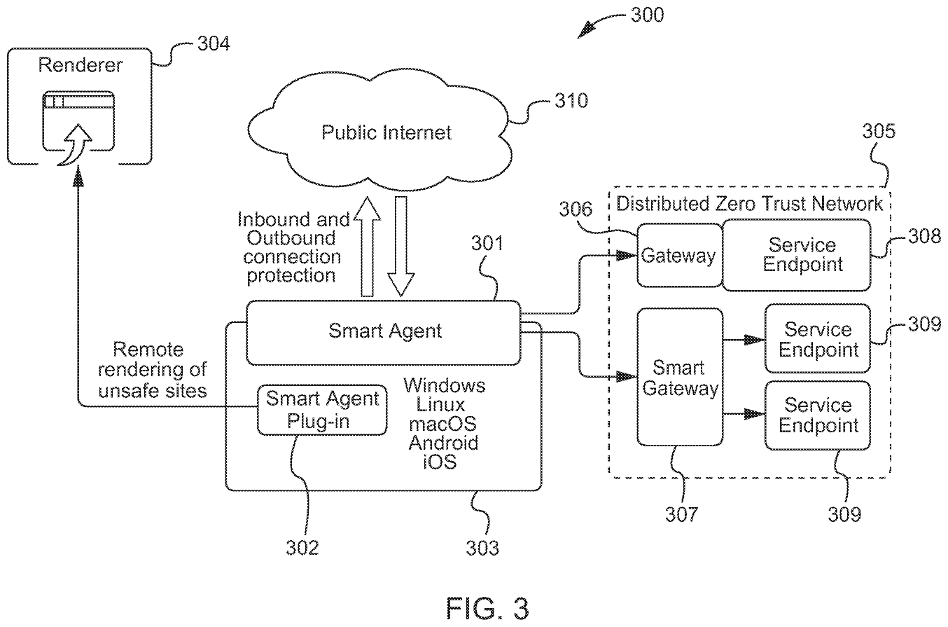

FIG. 3 depicts environment 300, which may include smart agent 301. Smart agent 301 may further include smart agent 302 and/or various operating systems 303, such as WINDOWS, LINUX, MACOS, ANDROID, AND IOS.

Smart agent plug-in 302 may be in communication with renderer 304.

Smart agent 301 may also be in communication with distributed zero trust network 305. For example, smart agent 301 may communicate with gateway 306 and/or smart gateway 307, both of distributed zero trust network 305. Furthermore, gateway 306 may include service endpoint 308, while smart gateway 307 may include multiple service endpoints 309.

The above detailed description may be of a small number of embodiments, and is not intended to be limiting in scope. One of ordinary skill in this art would understand that some example embodiments described herein could be applied in areas or fields other than those described herein.

### PARTIAL GLOSSARY

API Application Programming Interface
CSV Comma-Separated Values
DNS Domain Name System
FQDN Fully Qualified Domain Name
HTML HyperText Markup Language
IaaS Infrastructure as a Service
IoT Internet of Things
IP Internet Protocol
MITM Man-in-the-Middle
OT Operational Technology
PaaS Platform as a Service
PDF Portable Document Format
PII Personal Identifiable Information
SaaS Software as a Service
SRC Source
TFTP Trivial File Transfer Protocol
VPC Virtual Private Cloud

We claim:

1. A method comprising:
determining, by a device, whether a data stream is approved or unapproved; and
transmitting, by the device, a fetch request to a renderer requesting a network resource requested by a protected client.

2. The method of claim 1, wherein the device is in communication with a distributed zero trust network.

3. The method of claim 1, wherein the device comprises at least one plug-in.

4. The method of claim 1, wherein the device is in communication with a rendering device configured to remotely render unsafe content.

5. The method of claim 1, wherein the device is configured for inbound and outbound connection protection with a public internet.

6. A method comprising:
receiving, by a rendering device, a fetch request from a device requesting at least one network resource requested by a protected client;
requesting, by the rendering device, the requested at least one requested resource; and
rendering, by the rendering device, the at least one requested resource.

7. The method of claim 6, wherein the rendering device is in communication with a smart device.

8. An apparatus comprising:
at least one processor; and
at least one memory storing instructions that, when executed by the at least one processor, cause the apparatus at least to:
determine whether a data stream is approved or unapproved; and
transmit a fetch request to a renderer requesting a network resource requested by a protected client.

9. The apparatus of claim 8, wherein the apparatus is in communication with a distributed zero trust network.

10. The apparatus of claim 8, wherein the apparatus comprises at least one plug-in.

11. The apparatus of claim 8, wherein the apparatus is in communication with a rendering device configured to remotely render unsafe content.

12. The apparatus of claim 8, wherein the apparatus is configured for inbound and outbound connection protection with a public internet.
